(19) United States
(12) Patent Application Publication
(10) Pub. No.: US 2006/0227880 A1
(43) Pub. Date: Oct. 12, 2006

(54) Reducing motion compensation memory bandwidth through filter utilization

(76) Inventors: Stephen Gordon, North Andover, MA (US); Darren Neuman, Palo Alto, CA (US)

Correspondence Address: MCANDREWS HELD & MALLOY, LTD, 500 WEST MADISON STREET, SUITE 3400, CHICAGO, IL, 60661, US

(21) Appl. No.: 11/101,955

(22) Filed: Apr. 8, 2005

Related U.S. Application Data
(60) Provisional application No. 60/581,148, filed on Jun. 18, 2004.

(51) Int. Cl. H04N 11/02; H04N 7/12; H04N 11/04; H04B 1/66

(52) U.S. Cl. 375/240.25; 375/240.01

(57) ABSTRACT

A system and method for processing video information. Various aspects of the present invention may comprise receiving encoded video information at a video processing system. An indication of utilization for at least one system resource of the video processing system may be determined. Such a system resource may, for example, comprise memory access bandwidth. A decoding strategy of a plurality of decoding strategies may be identified based, at least in part, on the determined indication(s) of utilization. The identified decoding strategy may, for example and without limitation, comprise a decoding strategy that does not conform to the encoding standard with which the encoded video information was encoded. The encoded video information may then be decoded according to the identified decoding strategy.

### CROSS-REFERENCE TO RELATED APPLICATIONS/INCORPORATION BY REFERENCE

This patent application is related to and claims priority from provisional patent application Ser. No. 60/581,148, filed Jun. 18, 2004, and titled “REDUCING MOTION COMPENSATION MEMORY BANDWIDTH THROUGH FILTER UTILIZATION,” the contents of which are hereby incorporated herein by reference in their entirety.

### FEDERALLY SPONSORED RESEARCH OR DEVELOPMENT

Not Applicable

### SEQUENCE LISTING

Not Applicable

### MICROFICHE/COPYRIGHT REFERENCE

Not Applicable

### BACKGROUND OF THE INVENTION

Video communication systems may utilize any of a variety of video encoding techniques to efficiently utilize limited communication bandwidth. Such systems generally utilize relatively low amounts of communication bandwidth at the expense of relatively high amounts of data processing on the transmitting and receiving systems.

Many modern video communication systems utilize video compression (or encoding) based on motion compensation. Decoding video information that has been encoded with a motion compensation technique (e.g., particularly in real-time) may require a relative large amount of memory access bandwidth. For example and without limitation, accessing reference video information for motion compensation processing may require a relatively large amount of memory access bandwidth.

During the communication of video information, any of a variety of events may occur that affect the amount of memory bandwidth (or other system resources) needed to process video information. For example and without limitation, source or channel transmission errors may occur. Additionally, for example, data processing errors may occur. Such errors may cause a video processing system to increase desired amount of memory access.

The general trend has been to compensate for increasing memory access bandwidth needs by providing relatively larger amounts of memory access bandwidth through the utilization of larger memory modules (e.g., providing more data per read) and memory types with multiple memory accesses per read cycle (e.g., dual data rate and quadruple data rate memory chips). For various types of memory accesses, however, increasing memory access bandwidth using the above solutions might increase video decoder performance by only a low amount relative to the cost of such solutions.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention provide a system and method for processing video information, substantially as shown in and/or described in connection with at least one of the figures, as set forth more completely in the claims. These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 is a block diagram of an exemplary video processing system, in accordance with various aspects of the present invention.

FIG. 2 is a flow diagram illustrating an exemplary method for processing video information, in accordance with various aspects of the present invention.

FIG. 3 is a block diagram of an exemplary video processing system, in accordance with various aspects of the present invention.

FIG. 4 is a flow diagram illustrating an exemplary method for processing video information, in accordance with various aspects of the present invention.

### DETAILED DESCRIPTION OF THE INVENTION

Generally, in motion compensation, an encoder may specify the current video block size, a spatial displacement and a temporal displacement. Using this information, the decoder may form a prediction for the current video block. The spatial displacement may be referred to as the “motion vector,” and the temporal displacement may be referred to as the “reference frame.” Typically, the reference frame is stored in memory (e.g., DRAM) and the decoder must fetch the 2D region from memory. However, because the motion vector might specify a sub-pixel displacement in x and/or y directions, the decoder must extend the 2D region to the left, right, top, and bottom to include pixels covered by the extent of the sub-pixel interpolation filter(s). The video processor may then, for example, utilize one or more filter circuits to interpolate video data at pixel resolution to generate video data at sub-pixel resolution.

Various methods may be utilized to increase memory access bandwidth (e.g., for general increased bandwidth or increased bandwidth during intermittent periods). For example, wider memory with more data access lines may be utilized. Also, faster access memory may be utilized. Additionally, double-data rate (DDR) memory or quadruple data-rate (DDR-II) memory may be utilized. Various memory solutions may provide for larger amounts of data to be accessed more quickly, thereby providing for a higher raw memory access bandwidth. However, in various scenarios, generally increasing memory access bandwidth to provide memory access bandwidth for occasional intermittent periods of increased need might not be a cost-effective solution.

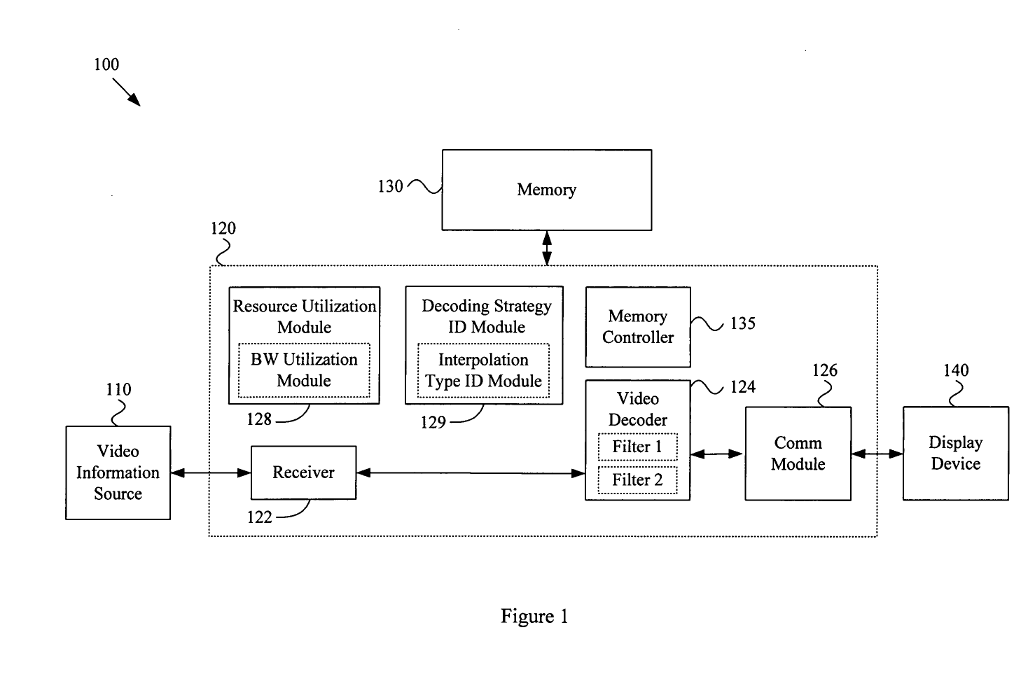

FIG. 1 is a block diagram of an exemplary video processing system 100, in accordance with various aspects of the present invention. The exemplary system 100 may comprise a video information source 110 that provides encoded video information to a video processing subsystem 120. The video processing subsystem 120 may utilize a memory 130 and memory controller 135 for storing and/or retrieving data for video processing. The video processing subsystem 120 may communicate decoded video information to a display device 140.

The exemplary video processing system 100 may comprise a receiver 122 (or receiver module), communicatively coupled to the video information source 110, that receives encoded video information from the video information source 110. The system 100 may also comprise a resource utilization module 128 that monitors and/or determines an indication of utilization for at least one system resource of the video processing system 100. The system 100 may additionally comprise a decoding strategy identification module 129 that identifies, based at least in part on the utilization level(s) determined by the resource utilization module 128, which of a plurality of decoding strategies to utilize to decode the encoded video information.

The system 100 may further comprise a video decoder 124 (or video decoder module) that receives encoded video information (e.g., as received by the receiver 122) and decodes the encoded video information (e.g., according to the decoding strategy identified by the decoding strategy identification module 129). The system 100 may also comprise a communication module 126 that receives decoded video information (e.g., from the video decoder 124) and communicates one or more signals representative of the decoded video information to any of a variety of downstream entities. The system 100 may also comprise a display device 140, which receives one or more signals representative of decoded video information (e.g., from the communication module 126) and presents a visible representation of the decoded video information. Various components of the exemplary video processing system 100 will now be discussed in more detail.

The video information source 110 may comprise characteristics of any of a number of video information sources. For example and without limitation, the video information source 110 may comprise a communication network transmitter. Such a networked video information source may, for example, communicate encoded video information over any of a number of media and utilizing any of a number of communication protocols.

For example and without limitation, the video information source 110 may communicate information over a cable or satellite television communication network using an MPEG protocol (e.g., MPEG-2; or MPEG-4, part 10 (a.k.a., AVC and H.264)). Also for example, the video information source 110 may communicate information over a computer communication network (e.g., the Internet, a local area network, wide area network, metropolitan area network, personal area network, etc.). Additionally for example, the video information source 110 may communicate video information over a telecommunication network (e.g., a hard-wired network, satellite telephone network, or a wireless cellular network). Accordingly, the scope of various aspects of the present invention should not be limited by characteristics of any particular type of communication network over which encoded video information may be communicated.

Also for example, the video information source 110 may comprise a receiver of encoded video information that is communicated through a communication network. For example, in a non-limiting exemplary scenario, the video information source 110 may comprise one or more components of a cable television receiver, satellite television receiver, computer modern, wireless telephone receiver, etc. Such a video information source 110 may, for example, receive one or more signals communicating encoded video information, determine the encoded video information from the one or more signals, and provide the encoded video information to the video processing subsystem 120. Note that in such an exemplary scenario, the functionality of the video information source 110 may merge with the functionality of the receiver 122.

Additionally for example, the video information source 110 may comprise a device capable of reading information from an information storage medium. For example and without limitation, the video information source 110 may comprise characteristics of a digital versatile disc (“DVD”) drive or compact disc (“CD”) drive. Also for example, the video information source 110 may comprise characteristics of a hard drive, mini-hard drive or zip drive interface. Further for example, the video information source 110 may comprise characteristics of any of a variety of solid-state memory drives (e.g., interfacing with memory cards, sticks, modules, flash drives, thumb drives, etc.). Note that in such an exemplary scenario, the functionality of the video information source 110 may merge with the functionality of the receiver 122.

Note that, depending on the specific type of video information source 110, the video information source 110 may be spatially related to the video processing subsystem 120 (e.g., including the video decoder 124) in any of a variety of manners. For example and without limitation, the video information source 110 may reside on the same integrated circuit as the video processing subsystem 120 or components thereof. Also for example, the video information source 110 may reside on the same circuit board or in the same chassis as the video processing subsystem 120. Further for example, the video information source 110 may reside in a different chassis, different building or different campus from the video processing subsystem 120. Still further for example, the video information source 110 and the video processing subsystem 120 may reside at respective geographical locations coupled to a worldwide communication network (i.e., virtually anywhere in relation to each other).

In general, the video information source 110 may comprise characteristics of any of a large variety of video information sources. Accordingly, the scope of various aspects of the present invention should not be limited by characteristics of a particular type of video information source.

The encoded video information communicated by the video information source 110 may comprise characteristics of any of a variety of types of encoded video information. For example, in a non-limiting exemplary scenario, the encoded video information may be encoded in a manner commensurate with a block encoding technique. A block encoding technique may generally, for example, describe a block of video information relative to one or more other blocks of video information (e.g., temporally or spatially adjacent blocks). The various MPEG encoding strategies provide illustrative examples of video block encoding, but by no means is video block encoding limited to the various MPEG encoding strategies.

As mentioned previously, the receiver 122 may generally receive encoded video information (e.g., from the video information source 110 or other source). The receiver 122 may, for example, receive one or more signals communicating encoded video information and output one or more data streams corresponding to the encoded video information. The receiver 122 may comprise characteristics of any of a variety of communication receivers. The receiver 122 may, for example, be adapted to receive video information communicated over any of a variety of media (e.g., wired, wireless RF, tethered optical, non-tethered optical, etc.) and use any of a large variety of communication protocols (e.g., standard or proprietary communication protocols). For example and without limitation, the receiver 122 may comprise characteristics of a satellite communication receiver, a cable television receiver, an optical signal receiver, a computer modern, a wireless telephone receiver, a wireless router receiver, a data port, etc. Accordingly, the scope of various aspects of the present invention should not be limited by characteristics of any particular type of receiver.

As mentioned previously, the video decoder 124 may decode encoded video information (e.g., in accordance with an identified encoding strategy). The video decoder 124 may, for example, be adapted to decode video information according to any of a plurality of decoding strategies.

In a first non-limiting exemplary scenario, the video decoder 124 may be adapted to decode information utilizing at least a first decoding strategy and/or a second decoding strategy. The first decoding strategy may, for example, correspond to relatively high memory bandwidth utilization. For example, the first decoding strategy may correspond to a relatively large amount of data reading and/or writing while performing the first decoding strategy. The second decoding strategy may, for example, correspond to relatively low memory bandwidth utilization. For example, the second decoding strategy may correspond to a relatively small amount of data reading and/or writing while performing the second decoding strategy.

In a second non-limiting exemplary scenario, the video decoder 124 may be adapted to decode information utilizing at least a first decoding strategy and/or a second decoding strategy. The first decoding strategy may, for example, correspond to the encoding strategy utilized to encode the video information being decoded, and may also be referred to herein as a “conforming decoding strategy.” The second decoding strategy may, for example, not correspond to the encoding strategy utilized to encode the video information being decoded, and may also be referred to herein as a “non-conforming decoding strategy.”

In a third non-limiting exemplary scenario, the video decoder 124 may be adapted to decode information utilizing at least a first decoding strategy and/or a second decoding strategy. The first decoding strategy may, for example, comprise utilizing an n-tap filter to interpolate video information between pixels. The second decoding strategy may, for example, comprise utilizing an m-tap filter to interpolate video information between pixels, where m is different from (e.g., less than) n. For example and without limitation, the first decoding strategy may comprise utilizing a 6-tap filter to interpolate video information between pixels (e.g., as may be specified by the MPEG-4, part 10 standard), and the second decoding strategy may comprise utilizing a 2-tap filter to interpolate video information between pixels (e.g., as may be different from the filter specified by the MPEG-4, part 10 standard).

The video decoder 124 may comprise any of a variety of data or signal routing mechanisms to utilize in selecting between at least a first decoding strategy and a second decoding strategy. For example and without limitation, the video decoder 124 may comprise one or more multiplexers, de-multiplexers, digital switches, etc. that the video decoder 124 may utilize to route data or signals between various decoder sub-modules. Note that various aspects of the video decoder 124 may be implemented in hardware and/or software. Accordingly, the video decoder 124 may also utilize software commands to implement and/or utilize either of the at least first and second decoding strategies.

In general, the video decoder 124 may decode encoded video information according to an identified decoding strategy. Accordingly, the scope of various aspects of the present invention should not be limited by characteristics of any particular video decoder or video decoding strategy.

As mentioned previously, the resource utilization module 128 may determine an indication of utilization for at least one system resource of the video processing system 100. System resources may comprise, without limitation, memory access bandwidth, system energy (e.g., supply and/or demand), general decoding processing resources, heat dissipation resources, communication link resources, etc. An indication of utilization for a system resource may comprise various characteristics indicative (e.g., directly or indirectly) of system resource utilization. Such an indication may, for example, take the form of an electrical signal and/or data. For example and without limitation, an indication of utilization may indicate current or predicted system resource usage or availability. Also for example, an indication of utilization may indicate whether a proposed resource utilization will be allowed or successful (e.g., timely or accurate). Accordingly, the scope of various aspects of the present invention should not be limited by characteristics of any particular indication of current or predicted system resource utilization).

The resource utilization module 128 may determine an indication of utilization in any of a variety of manners. In a non-limiting exemplary scenario where the at least one system resource comprises memory bandwidth, the resource utilization module 128 may determine an indication of utilization for the memory bandwidth (e.g., memory access bandwidth for the memory 130). The resource utilization module 128 may, for example, determine an indication of utilization for memory bandwidth based on current memory bandwidth utilization and/or predicted memory bandwidth utilization.

For example, the resource utilization module 128 may determine an indication of utilization for the memory bandwidth by monitoring the current utilization of memory bandwidth. Also for example, the resource utilization module 128 may determine an indication of utilization for the memory bandwidth by communicating with one or more other system entities (e.g., the memory controller 135) to determine the current utilization level for the memory bandwidth. Further for example, the resource utilization module 128 may determine an indication of utilization for the memory bandwidth by communicating with the memory controller 135 to determine if a pending or proposed memory access request might be denied or might not execute successfully (e.g., timely or accurately).

Also for example, the resource utilization module 128 may determine an indication of utilization for the memory bandwidth by predicting (or anticipating) future memory bandwidth utilization. The resource utilization module 128 may, for example, make such a prediction based, at least in part, on predicted data access volume. The resource utilization module 128 may predict data access volume in any of a variety of manners. For example and without limitation, the resource utilization module 128 may predict data access volume based, at least in part, on analysis of past data access. Also for example, the resource utilization module 128 may predict data access volume based, at least in part, on analysis of the decoding needs associated with current or future encoded video information.

Also for example, the resource utilization module 128 may make such a prediction based, at least in part, on data alignment in the memory (e.g., the memory 130). For a particular memory access, the amount of memory access bandwidth utilized may vary in accordance with the placement of data in memory relative to data access boundaries. For example, in a scenario where a desired data block is aligned with an access boundary, a single memory access may be sufficient to access the desired data block. Alternatively, where the desired data block spans multiple data access boundaries, multiple memory accesses may be necessary to access the desired data block, which corresponds to greater utilization of memory bandwidth. Thus, accessing a same amount of data may require the utilization of varying amounts of memory bandwidth, depending on the alignment of desired data relative to data access boundaries.

Further for example, the resource utilization module 128 may predict a utilization level for the memory bandwidth based on current and/or past monitoring of the utilization of memory bandwidth. Also for example, the resource utilization module 128 may determine an indication of utilization for the memory bandwidth by communicating with one or more other system entities (e.g., the memory controller 135) to predict a utilization level for the memory bandwidth.

In the previous example, the resource utilization module 128 generally determined an indication of utilization for memory bandwidth. As illustrated by the previous example, the resource allocation module 128 may determine an indication of utilization for memory bandwidth in any of a variety of manners. Accordingly, the scope of various aspects of the present invention should not be limited by characteristics of any particular manner of determining an indication of memory bandwidth utilization (e.g., past, current or future utilization).

As mentioned previously, though the prior discussion focused on memory bandwidth as the system resource for which an indication of utilization was determined, it should be noted that various aspects of the present invention are readily extensible to other system resources. For example and without limitation, the resource utilization module 128 may determine an indication of utilization for system energy. Such an indication of utilization may, for example, comprise an indication of level of energy available (e.g., either current or predicted). Such an indication of utilization may also, for example, comprise an indication of level of energy currently being utilized for video processing or a predicted level of energy utilization for future video processing. In such an exemplary scenario, the resource utilization module 128 may communicate with a power management unit (or other system entity) to determine any of a variety of energy utilization information. Accordingly, the scope of various aspects of the present invention should not be limited by characteristics of a particular system resource for which an indication of utilization may be determined.

As mentioned previously, the decoding strategy identification module 129 may identify, based at least in part on a determined indication(s) of resource utilization (e.g., as determined by the resource utilization module 128), which of a plurality of decoding strategies to utilize to decode encoded video information (e.g., as received by the receiver 122). Also discussed previously, were various exemplary decoding strategies that might be utilized by the video decoder 124.

The decoding strategy identification module 129 may identify a decoding strategy in any of a variety of manners. For example and without limitation, the decoding strategy identification module 129 may determine (e.g., analytically or empirically) resource utilization levels associated with particular decoding strategies. The decoding strategy identification module 129 may then, for example based on one or more indications of resource utilization determined by the resource utilization module 128, identify a best decoding strategy in light of the current or predicted resource utilization. Also for example and without limitation, the decoding strategy identification module 129 may maintain a cross-list of decoding strategies to utilize given particular indications of resource utilizations (e.g., as determined by the resource utilization module 128).

In a first non-limiting exemplary scenario, the plurality of decoding strategies may comprise a first (e.g., generally preferred) decoding strategy that utilizes a relatively high memory bandwidth (e.g., reading and/or writing a relatively large amount of information from/to memory). The plurality of decoding strategies may also comprise a second decoding strategy that utilizes a relatively low memory bandwidth (e.g., reading and/or writing a relatively small amount of information from/to memory). The decoding strategy identification module 129 may, for example, determine that current memory bandwidth utilization (e.g., as determined by the resource utilization module 129) is low enough, so there is sufficient available memory bandwidth for utilizing the first decoding strategy, and therefore identify the first decoding strategy to utilize. Alternatively, for example, the decoding strategy identification module 129 may determine that predicted memory bandwidth utilization (e.g., as determined by the resource utilization module 128) is too high to utilize the first decoding strategy, and therefore identify the second decoding strategy to utilize (e.g., even if the first decoding strategy is generally preferred).

In a second non-limiting exemplary scenario, the plurality of decoding strategies may comprise a first decoding strategy that utilizes an n-tap filter to interpolate video information between video data points (e.g., corresponding to video pixels), and a second decoding strategy that utilizes an m-tap filter to interpolate video information between video data points (e.g., where m < > n or where m<n). The decoding strategy identification module 129 may, for example, determine that memory bandwidth utilization associated with the n-tap filter is too high for current memory bandwidth utilization, and therefore identify the second decoding strategy (e.g., with the m-tap filter) to utilize for decoding, even though the first decoding strategy utilizing the n-tap filter may generally yield superior results to the second decoding strategy utilizing the m-tap filter.

In a third non-limiting exemplary scenario, the plurality of decoding strategies may comprise a first decoding strategy that utilizes a 6-tap filter (e.g., an FIR filter) to interpolate video information (e.g., in conformance to a particular video communication standard utilized to communicate the encoded video information). The plurality of decoding strategies may also comprise a second decoding strategy that utilizes a 2-tap filter to interpolate video information (e.g., in a manner that does not conform to the particular video communication standard utilized to communicate the encoded video information). The decoding strategy identification module 129 may determine (e.g., in light of memory bandwidth utilization information provided by the resource utilization module 128) that utilizing the 6-tap interpolation filter is appropriate, and therefore identify the first decoding strategy for decoding the encoded video information. Alternatively for example, the decoding strategy identification module 129 may determine that current and/or predicted memory bandwidth utilization is too high to utilize the 6-tap interpolation filter, and therefore identify the second decoding strategy (e.g., with the 2-tap interpolation filter) for decoding the encoded video information. The decoding strategy identification module 129 may make such a determination even though the 2-tap interpolation filter does not conform to the communication standard utilized to communicate the encoded video information.

The previous exemplary scenarios discussed the selection of decoding strategies based on memory bandwidth utilization. It should be noted that various aspects of the present invention are readily extensible to the utilization of other system resources. For example and without limitation, other system resources may also comprise energy resources, heat dissipation resources, communication link resources, digital signal processing resources, general decoding resources, etc.

In a non-limiting exemplary scenario, the plurality of decoding strategies may comprise a first decoding strategy that utilizes a first amount of energy resources and a second decoding strategy that utilizes a second amount of energy resources. For example, the first decoding strategy may be preferred to the second decoding strategy, but may utilize a relatively higher amount of energy. The decoding strategy identification module 129 may (e.g., in view of energy resource utilization information obtained from the resource utilization module 128), determine that current and/or predicted available energy resources are too low to utilize the first decoding strategy, and therefore identify the second decoding strategy to utilize to decode encoded video information. For example and without limitation, the first decoding strategy might conform to a standard utilized to communicate the encoded video information, and the second decoding strategy might not conform to the standard.

The previous exemplary scenarios discussed decoding strategy selection between two decoding strategies. The previous exemplary scenarios discussed selection between only two decoding strategies for illustrative simplicity. It should be noted that various aspects of the present invention are readily extensible to selection between three or n decoding strategies.

In general, the decoding strategy identification module 129 may, based at least in part on one or more indications of system resource utilization, identify which of a plurality of decoding strategies to utilize to decode encoded video information. Accordingly, the scope of various aspects of the present invention should not be limited by characteristics of any particular manner of identifying a decoding strategy based, at least in part, on system resource utilization.

As mentioned previously, the communication module 126 may receive decoded video information (e.g., from the video decoder 124) and communicate one or more signals representative of the decoded video information to any of a variety of downstream entities. The communication module 126 may, for example, be communicatively coupled to the video decoder 124. The communication module 126 may, for example, receive decoded video information from the video decoder module 124 and communicate such decoded video information to any of a variety of receivers of such information through one or more communication links.

The communication module 126 may comprise characteristics of any of a variety of communication modules. The communication module 126 may, for example, comprise one or more transmitters that communicate information over any of a variety of communication media (e.g., wired, wireless, tethered optical, or non-tethered optical). The communication module 126 may also, for example, communicate the decoded video information utilizing any of a large variety of communication protocols that may be utilized to communicate information (e.g., computer communication protocols, television communication protocols, telecommunication protocols, etc.). Additionally, the communication module 126 may communicate video signals that directly drive video display devices or televisions (e.g., the display device 140). Accordingly, the scope of various aspects of the present invention should not be limited by characteristics of any particular communication module that may communicate video information.

In a non-limiting exemplary scenario, the communication module 126 may receive decoded video data from the video decoder 124 and communicate such decoded video data to a video receiver. In another non-limiting exemplary scenario, the communication module 126 may utilize a video display driver module to communicate such video information to a video display in the form of one or more display driver signals. In yet another non-limiting exemplary scenario, the communication module 126 may utilize a television driver module to communicate such decoded video information to a television (e.g., standard definition or high definition television) in the form of one or more television input signals. For example, the communication module 126 may output component and/or composite video signals.

The communication module 126 may, for example, receive decoded video information from the video decoder 124 and communicate the decoded video information to a local video receiver or a distant video receiver. In a non-limiting exemplary scenario, the communication module 126 may reside within a chassis of a video display device (e.g., a display or television) and communicate the decoded video information to local circuitry that generates visible video information. In another non-limiting exemplary scenario, the communication module 126 may reside in a cable or satellite receiver box or a computer chassis, which is communicatively coupled to a display device. The communication module 126 may then, for example, communicate the decoded video information (i.e., one or more signals representative thereof) to the communicatively coupled display device. In yet another non-limiting exemplary scenario, the communication module 126 may reside on a video server of an office, building or campus, which is communicatively coupled by a data communication network to various devices with video display capability. The communication module 126 may, for example, communicate the decoded video information to the various devices over the data communication network in a manner commensurate with video data communication over the data communication network.

In general, the communication module 126 may receive decoded video information (e.g., from the video decoder 124) and communicate such decoded video information to any of a variety of video receivers. Accordingly, the scope of various aspects of the present invention should not be limited by characteristics of any particular manner of, or mechanism for, communicating decoded video information to a receiver of such information.

The display device 140 of the video processing system 100 may be communicatively coupled to the communication module 126. The display device 140 may, for example, receive one or more display driver signals from the communication module 126, where the display driver signal(s) is representative of decoded video information, and output a visible representation of the decoded video information. The display device 140 may comprise characteristics of any of a variety of video display devices (e.g., television or computer monitors, handheld displays, cathode ray tubes, plasma displays, LCD displays, etc.). The display device 140 may, for example, be integrated with the video processing subsystem 120 or may be an independent device. The scope of various aspects of the present invention should not be limited by characteristics of any particular type of display device.

The previous discussion presented the exemplary video processing system 100. The various modules or components of the exemplary video processing system 100 may be implemented utilizing hardware, software and/or a combination thereof. Additionally, various modules may share various hardware and/or software components. For example and without limitation, a first module and a second module may share various hardware components or software sub-routines. Accordingly, the scope of various aspects of the present invention should not be limited by characteristics of any particular module implementations or by arbitrary notions of module boundaries.

The exemplary video processing system 100 was presented above to provide specific illustrations of various broader aspects of the present invention. Accordingly, the scope of various aspects of the present invention should not be limited by characteristics of the exemplary video processing system 100.

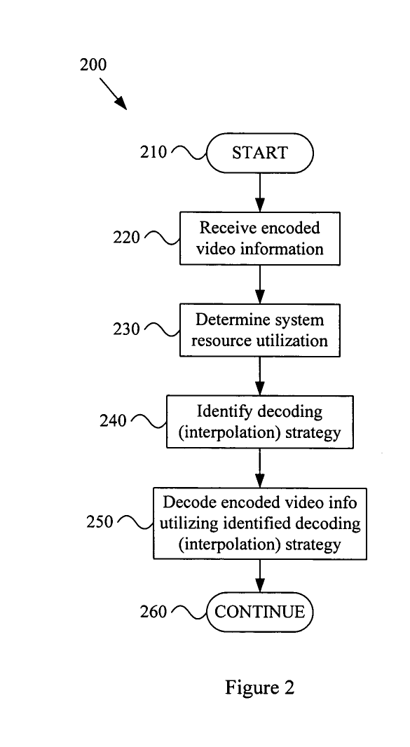

FIG. 2 is a flow diagram illustrating an exemplary method 200 for processing video information, in accordance with various aspects of the present invention. The exemplary method 200 may, for example and without limitation, share various functional characteristics with the exemplary video processing system 100 illustrated in FIG. 1 and discussed previously. For example, the exemplary method 200 may be implemented in any of a variety of systems with video processing capability. Such systems may, for example and without limitation, comprise a satellite communication receiver, cable television receiver, optical signal receiver, computer modern, wireless telephone, computer network server, personal wireless router, etc.

The exemplary method 200 may begin execution at step 210. The exemplary method 200 (and other methods discussed herein) may begin execution for any of a large variety of reasons. For example and without limitation, the method 200 may begin execution upon powering up or resetting a video processing system implementing the method 200. Also for example, the exemplary method 200 may begin execution in response to a command received from another system component or from a user. Further for example, the exemplary method 200 may begin execution in response to a detected system condition. Accordingly, the scope of various aspects of the present invention should not be limited by characteristics of any particular initiating cause or condition.

The exemplary method 200 may, at step 220, comprise receiving encoded video information. Step 220 may, for example and without limitation, share various functional characteristics with the receiver 122 of the exemplary video processing system 100 illustrated in FIG. 1 and discussed previously. Step 220 may also, for example, share various functional characteristics with receiving aspects of the video information source 110 of the exemplary video processing system 100 illustrated in FIG. 1. Step 220 may comprise receiving encoded video information in any of a variety of manners.

As explained previously with regard to the exemplary receiver 122 and video information source 110, the encoded video information may comprise any of a variety of encoded video information characteristics. For example and without limitation, the encoded video information may comprise characteristics of video information encoded with a block encoding technique (e.g., MPEG-2; and MPEG-4, part 10).

Also as explained previously with regard to the exemplary receiver 122 and video information source 110, step 220 may comprise receiving encoded video information from any of a variety of communication sources, over any of a variety of communication media, and utilizing any of variety of communication protocols. For example and without limitation, step 220 may comprise receiving encoded video information from a communication network transmitter (e.g., a terrestrial or satellite television transmitter, a networked video server, etc.). Also for example, step 220 may comprise receiving encoded video information over a computer communication network or telecommunication network. Further for example, step 220 may comprise receiving encoded video information from various readable data storage media.

Step 220 may, for example, comprise receiving encoded video information over a wired media, wireless media, tethered optical media or non-tethered optical media. Step 220 may further, for example, comprise receiving the encoded video information utilizing any of a variety of communication protocols (e.g., standard and/or proprietary protocols). Step 220 may also, for example, comprise receiving encoded video information from a geographically local source or from a geographically remote source.

Generally, step 220 may comprise receiving encoded video information. Accordingly, the scope of various aspects of the present invention should not be limited by characteristics of any particular type of encoded video information, any particular source of such encoded video information, or any particular manner of receiving such encoded video information.

The exemplary method 200 may, at step 230, comprise determining an indication of utilization for at least one system resource of the video processing system. Step 230 may, for example and without limitation, share various functional characteristics with the resource utilization module 128 of the exemplary video processing system 100 illustrated in FIG. 1 and discussed previously. System resources may comprise, without limitation, memory access bandwidth, system energy (e.g., supply and/or demand), heat dissipation resources, digital signal processing resources, communication link resources, general decoding resources, etc. Step 230 may comprise determining an indication of utilization in any of a variety of manners.

In a non-limiting exemplary scenario where the at least one system resource comprises memory bandwidth, step 230 may comprise determining an indication of utilization for the memory bandwidth (e.g., memory access bandwidth). Step 230 may, for example, comprise determining an indication of utilization for memory bandwidth based on current memory bandwidth utilization and/or predicted memory bandwidth utilization.

For example, step 230 may comprise determining an indication of utilization for the memory bandwidth by monitoring the current utilization of memory bandwidth. Also for example, step 230 may comprise determining an indication of utilization for the memory bandwidth by communicating with one or more other system entities (e.g., a memory controller) to determine the current utilization level for the memory bandwidth. Further for example, step 230 may comprise determining an indication of utilization for the memory bandwidth by communicating with a memory controller to determine if a pending or proposed memory access request might be denied or might not execute successfully (e.g., timely or accurately).

Also for example, step 230 may comprise determining an indication of utilization for the memory bandwidth by predicting (or anticipating) future memory bandwidth utilization. Step 230 may, for example, comprise making such a prediction based, at least in part, on predicted data access volume. Step 230 may, in such a scenario, comprise predicting data access volume in any of a variety of manners. For example and without limitation, step 230 may comprise predicting data access volume based, at least in part, on analysis of past data access. Also for example, step 230 may comprise predicting data access volume based, at least in part, on analysis of the decoding needs associated with current or anticipated encoded video information.

Also for example, step 230 may comprise making such a prediction based, at least in part, on data alignment in memory. As mentioned previously, for a particular memory access, the amount of memory access bandwidth utilized may vary in accordance with the placement of data in memory relative to data access boundaries. For example, in a scenario where a desired data block is aligned with an access boundary, a single memory access may be sufficient to access the desired data block. Alternatively, where the desired data block spans multiple data access boundaries, multiple memory accesses may be necessary to access the desired data block, which corresponds to greater utilization of memory bandwidth. Thus, accessing a same amount of data may require the utilization of varying amounts of memory bandwidth, depending on the alignment of desired data relative to data access boundaries.

Further for example, step 230 may comprise predicting a utilization level for the memory bandwidth based on current and/or past monitoring of the utilization of memory bandwidth. Also for example, step 230 may comprise determining an indication of utilization for the memory bandwidth by communicating with one or more other system entities (e.g., a memory controller) to predict a utilization level for the memory bandwidth.

In the previous examples, step 230 generally comprised determining an indication of utilization for memory bandwidth. As illustrated by the previous examples, step 230 may comprise determining an indication of utilization for memory bandwidth in any of a variety of manners. Accordingly, the scope of various aspects of the present invention should not be limited by characteristics of any particular manner of determining memory bandwidth utilization (e.g., past, current or future utilization) or any indication thereof.

As mentioned previously, though the prior discussion focused on memory bandwidth as the system resource for which an indication of utilization was determined, it should be noted that various aspects of the present invention are readily extensible to other system resources. For example and without limitation, step 230 may comprise determining an indication of utilization for system energy. Such an indication of utilization may, for example, comprise an indication of energy available (e.g., either current or predicted). Such an indication of utilization may also, for example, comprise an indication of energy currently being utilized for video processing or a predicted level of energy utilization for future video processing. In such an exemplary scenario, the step 230 may comprise communicating with a power management unit (or other system entity) to determine any of a variety of energy utilization information. Accordingly, the scope of various aspects of the present invention should not be limited by characteristics of a particular system resource for which an indication of utilization may be determined.

The exemplary method 200 may, at step 240, comprise identifying, based at least in part on the determined indication(s) of resource utilization, which of a plurality of decoding strategies to utilize to decode the encoded video information. For example, the exemplary method 200 may, at step 240, comprise identifying, based at least in part on the determined indication(s) of resource utilization (e.g., as determined at step 230), which of a plurality of decoding strategies (e.g., as may be utilized at step 250) to utilize to decode the encoded video information (e.g., as received at step 220). Step 240 may, for example and without limitation, share various functional characteristics with the decoding strategy identification module 129 of the exemplary video processing system 100 illustrated in FIG. 1 and discussed previously.

Step 240 may, for example, comprise identifying a decoding strategy in any of variety of manners. For example and without limitation, step 240 may comprise determining (e.g., analytically or empirically) resource utilization levels associated with particular decoding strategies. Step 240 may then, for example based on the indication(s) of resource utilization determined at step 230, comprise identifying a best decoding strategy in light of the current or predicted resource utilization. Also for example, step 240 may comprise maintaining a cross-list of decoding strategies to utilize given particular indications of resource utilization (e.g., as determined at step 230).

In a first non-limiting exemplary scenario, the plurality of decoding strategies may comprise a first (e.g., preferred) decoding strategy that utilizes a relatively high memory bandwidth (e.g., reading and/or writing a relatively large amount of information from/to memory). The plurality of decoding strategies may also comprise a second decoding strategy that utilizes a relatively low memory bandwidth (e.g., reading and/or writing a relatively small amount of information from/to memory). Step 240 may, for example, comprise determining that current memory bandwidth utilization (e.g., as determined by step 230) is low enough, so there is sufficient available memory bandwidth for utilizing the first decoding strategy, and therefore comprise identifying the first decoding strategy to utilize. Alternatively, for example, step 240 may comprise determining that predicted memory bandwidth utilization (e.g., as determined by step 230) is too high to utilize the first decoding strategy, and therefore comprise identifying the second decoding strategy to utilize (e.g., even if the first decoding strategy is generally preferred).

In a second non-limiting exemplary scenario, the plurality of decoding strategies may comprise a first decoding strategy that utilizes an n-tap filter to interpolate video information between video data points (e.g., corresponding to video pixels), and a second decoding strategy that utilizes an m-tap filter to interpolate video information between video data points (e.g., where m < > n or where m<n). Step 240 may, for example, comprise determining that memory bandwidth utilization associated with the n-tap filter is too high for current memory bandwidth utilization, and therefore comprise identifying the second decoding strategy (e.g., with the m-tap filter) to utilize for decoding, even though the first decoding strategy utilizing the n-tap filter may generally yield superior results to the second decoding strategy utilizing the m-tap filter.

In a third non-limiting exemplary scenario, the plurality of decoding strategies may comprise a first decoding strategy that utilizes a 6-tap filter (e.g., an FIR filter) to interpolate video information (e.g., in conformance to a particular video communication standard utilized to communicate the encoded video information). The plurality of decoding strategies may also comprise a second decoding strategy that utilizes a 2-tap filter to interpolate video information (e.g., in a manner that does not conform to the particular video communication standard utilized to communicate the encoded video information). Step 240 may comprise determining (e.g., in light of the indication(s) of memory bandwidth utilization determined at step 230) that utilizing the 6-tap interpolation filter is appropriate, and therefore comprise identifying the first decoding strategy for decoding the encoded video information. Alternatively for example, step 240 may comprise determining that current and/or predicted memory bandwidth utilization is too high to utilize the 6-tap interpolation filter, and therefore comprise identifying the second decoding strategy (e.g., with the 2-tap interpolation filter) for decoding the encoded video information. Step 240 may comprise making such a determination even though the 2-tap interpolation filter does not conform to the communication standard utilized to communicate the encoded video information.

The previous exemplary scenarios discussed the selection of decoding strategies based on memory bandwidth utilization. It should be noted that various aspects of the present invention are readily extensible to the utilization of other system resources. For example and without limitation, other system resources may also comprise energy resources, hear dissipation resources, communication link resources, digital signal processing resources, general decoding resources, etc.

In a non-limiting exemplary scenario, the plurality of decoding strategies may comprise a first decoding strategy that utilizes a first amount of energy resources and a second decoding strategy that utilizes a second amount of energy resources. For example, the first decoding strategy may be preferred to the second decoding strategy, but may utilize a relatively higher amount of energy. In the exemplary scenario, step 240 may (e.g., in view of the indication(s) of energy resource utilization determined at step 230), comprise determining that current and/or predicted available energy resources are too low to utilize the first decoding strategy, and therefore comprise identifying the second decoding strategy to utilize to decode the encoded video information. For example and without limitation, the first decoding strategy might conform to a standard utilized to communicate the encoded video information, and the second decoding strategy might not conform to the standard.

The previous exemplary scenarios discussed decoding strategy selection between two decoding strategies. The exemplary scenarios discussed selection between only two decoding strategies for illustrative simplicity. It should be noted that various aspects of the present invention are readily extensible to selecting between three or n decoding strategies.

In general, step 240 may, based at least in part on one or more indications of system resource utilization, comprise identifying which of a plurality of decoding strategies to utilize to decode encoded video information. Accordingly, the scope of various aspects of the present invention should not be limited by characteristics of any particular manner of identifying a decoding strategy based, at least in part, on system resource utilization.

The exemplary method 200 may, at step 250, comprise decoding the encoded video information (e.g., as received at step 220) according to an identified decoding strategy (e.g., as identified at step 240). Step 250 may, for example and without limitation, share various functional characteristics with the video decoder 124 of the exemplary video processing system 100 illustrated in FIG. 1 and discussed previously.

Step 250 may, for example, comprise decoding the encoded video information according to any of a large variety of video decoding strategies. For example and without limitation, such decoding strategies may comprise any of a variety of decoding strategies corresponding to one or more video block encoding techniques.

In a first non-limiting exemplary scenario, step 250 may be capable of decoding encoded video information utilizing at least a first decoding strategy and/or a second decoding strategy. The first decoding strategy may, for example, correspond to relatively high memory bandwidth utilization. For example, the first decoding strategy may correspond to a relatively large amount of data reading and/or writing while performing the first decoding strategy. The second decoding strategy may, for example, correspond to relatively low memory bandwidth utilization. For example, the second decoding strategy may correspond to a relatively small amount of data reading and/or writing while performing the second decoding strategy.

In a second non-limiting exemplary scenario, step 250 may be capable of decoding encoded video information utilizing at least a first decoding strategy and/or a second decoding strategy. The first decoding strategy may, for example, correspond to the encoding strategy utilized to encode the video information being decoded, and may also be referred to herein as a “conforming decoding strategy.” The second decoding strategy may, for example, not correspond to the encoding strategy utilized to encode the video information being decoded, and may also be referred to herein as a “non-conforming decoding strategy.”

In a third non-limiting exemplary scenario, step 250 may be capable of decoding information utilizing at least a first decoding strategy and/or a second decoding strategy. The first decoding strategy may, for example, comprise utilizing an n-tap filter to interpolate video information between pixels. The second decoding strategy may, for example, comprise utilizing an m-tap filter to interpolate video information between pixels, where m is different from (e.g., less than) n. For example and without limitation, the first decoding strategy may comprise utilizing a 6-tap filter to interpolate video information between pixels (e.g., as may be specified by the MPEG-4, part 10 standard), and the second decoding strategy may comprise utilizing a 2-tap filter to interpolate video information between pixels (e.g., as may be different from the filter specified by the MPEG-4, part 10 standard).

Step 250 may comprise utilizing any of a variety of data or signal routing mechanisms, or software execution selection mechanisms, in selecting between at least a first decoding strategy and a second decoding strategy. For example and without limitation, the step 250 may comprise utilizing one or more multiplexers, de-multiplexers, digital switches, software branch instructions, etc. to route data or signals between various decoder modules (i.e., hardware and/or software modules). Note that various aspects of step 250 may be implemented in hardware and/or software.

In general, step 250 may comprise decoding encoded video information according to an identified decoding strategy. Accordingly, the scope of various aspects of the present invention should not be limited by characteristics of any particular type of video decoding strategy or manner of, or mechanism for, performing a particular type of video decoding.

The exemplary method 200 may, at step 260, comprise performing continued processing. Step 260 may comprise performing any of a large variety of continued processing. For example and without limitation, step 260 may comprise looping execution of the exemplary method 200 back up to step 220 to receive and decode additional encoded video information. Additionally, for example, step 260 may comprise performing user interface operations. Further for example, step 260 may comprise performing system fault detection or error reporting operations. Also for example, step 260 may comprise communicating decoded information to a system entity (e.g., for storage, further processing or visible presentation).

Step 260 may, for example, comprise communicating decoded video information over any of a variety of communication media (e.g., wired, wireless, tethered optical, or non-tethered optical). Step 260 may also, for example, comprise communicating the decoded video information utilizing any of a large variety of communication protocols that may be utilized to communicate information (e.g., computer communication protocols, television communication protocols, telecommunication protocols, etc.). Additionally, step 260 may comprise communicating video signals that directly drive video display devices or televisions (e.g., a video display device). Accordingly, the scope of various aspects of the present invention should not be limited by characteristics of any particular manner of communicating video information.

In a non-limiting exemplary scenario, step 260 may comprise communicating decoded video data (e.g., from step 250) to a video receiver. In another non-limiting exemplary scenario, step 260 may comprise communicating such video information to a video display device in the form of display driver signals. In yet another non-limiting exemplary scenario, step 260 may comprise communicating such decoded video information to a television (e.g., standard definition or high definition television) in the form of television input signals. For example, step 260 may comprise outputting component and/or composite video signals.

Step 260 may, for example, comprise communicating the decoded video information to a local video receiver or a distant video receiver. In a non-limiting exemplary scenario, step 260 may be implemented within a chassis of a video display device or television and comprise communicating the decoded video information to local circuitry that generates visible video information. In another non-limiting exemplary scenario, step 260 may be implemented in a cable or satellite receiver box or a computer chassis, which is communicatively coupled to a display device. Step 260 may then comprise, for example, communicating the decoded video information (i.e., one or more signals representative thereof) to the communicatively coupled display device. In yet another non-limiting exemplary scenario, the step 260 may be implemented on a video server of an office, building or campus, which is communicatively coupled by a data communication network to various devices with video display capability. Step 260 may then, for example, comprise communicating the decoded video information to the various devices over the data communication network in a manner commensurate with video data communication over the data communication network.

In general, step 260 may comprise communicating decoded video information to any of a variety of receivers. Accordingly, the scope of various aspects of the present invention should not be limited by characteristics of any particular manner of, or mechanism for, communicating decoded video information to a receiver of such information.

In general, step 260 may comprise performing any of a large variety of continued processing. Accordingly, the scope of various aspects of the present invention should not be limited by characteristics of any particular type of continued processing.

Exemplary method 200 was presented to provide specific examples of various generally broader aspects of the present invention. Accordingly, the scope of various aspects of the present invention should not be limited by specific characteristics of the exemplary method 200.

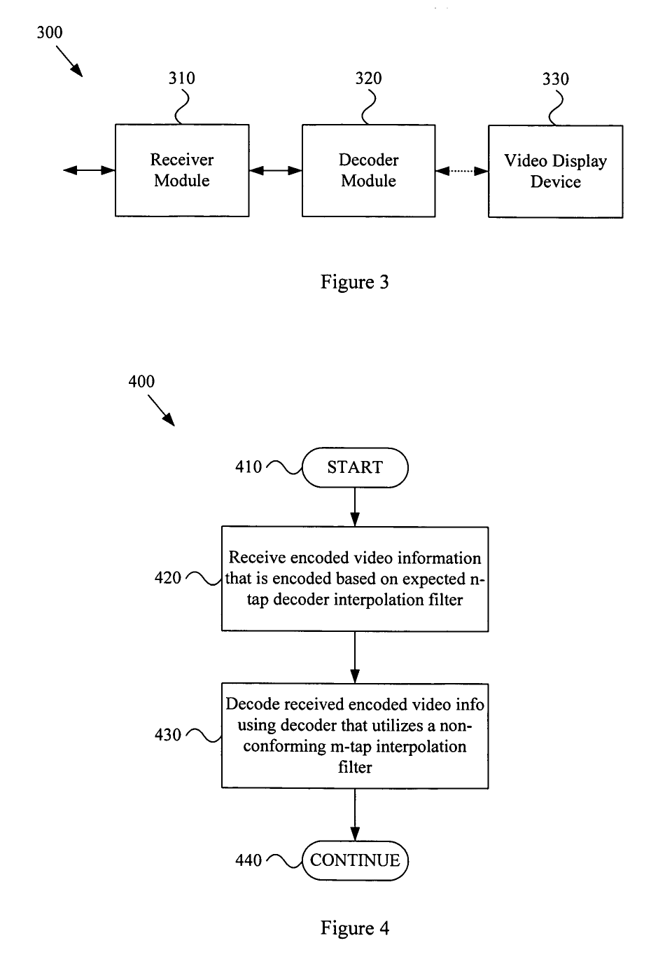

FIG. 3 is a block diagram of an exemplary video processing system 300, in accordance with various aspects of the present invention. The exemplary video processing system 300 may, for example and without limitation, share various characteristics with the exemplary video processing system 100 illustrated in FIG. 1 and discussed previously. Additionally, the exemplary video processing system 300 may share various functional characteristics with the exemplary method 200 illustrated in FIG. 2 and discussed previously.

As discussed previously with regard to the system 100 illustrated in FIG. 1, the exemplary system 300 may be implemented in any of a variety of devices or systems comprising video processing capability.

The exemplary video processing system 300 may comprise a receiver 310 (or receiver module). The receiver 310 may, for example, receive encoded video information, where the encoded video information resulted from a video encoding strategy that is based on a decoder utilizing an n-tap filter to interpolate between video information data points. Such a video encoding strategy may, for example and without limitation, comprise characteristics of a video block encoding strategy. The receiver 310 may, for example and without limitation, share various characteristics with the receiver 122 and the video information source 110 of the exemplary video processing system 100 illustrated in FIG. 1 and discussed previously.

The exemplary video processing system 300 may comprise a video decoder 320 (or decoder module) that decodes at least a portion of the encoded video information (e.g., as received by the receiver 310) utilizing an m-tap filter to interpolate between video information data points, where m does not equal n. For example, m may be less than n. The video decoder 320 may, for example and without limitation, share various characteristics with the video decoder 124 of the exemplary video processing system 100 illustrated in FIG. 1 and discussed previously.

In a first non-limiting exemplary scenario, the encoded video information received by the receiver 310 may comprise at least one video information stream, which comprises a first portion and a second portion. The second portion may, for example, be temporally sequentially related to the first portion. The video decoder 320 may, for example, decode the first portion of the video information stream utilizing an n-tap filter to interpolate between video information data points, and decode the second portion of the video information stream utilizing an m-tap filter to interpolate between video information data points. In the first non-limiting exemplary scenario, decoding the second portion of the video information stream utilizing an m-tap filter instead of an n-tap filter may result from a determination that utilizing the m-tap filter will result in the utilization of less system resources (e.g., memory bandwidth resources) than utilizing the n-tap filter.

In a second non-limiting exemplary scenario, the encoded video information received by the receiver 310 may comprise at least one video information stream, which comprises a first portion and a second portion. The encoded video information may have been encoded in accordance with an encoding standard that specifies the utilization of an n-tap filter to interpolate between video information data points (e.g., n=6). The video decoder 320 may, for example, decode the first portion of the video information stream utilizing an n-tap filter (e.g., n=6), as specified by the encoding standard, to interpolate between video information data points, and decode the second portion of the video information stream utilizing an m-tap filter (e.g., m=2), in violation of the encoding standard, to interpolate between video information data points. In the second non-limiting exemplary scenario, decoding the second portion of the video information stream utilizing an m-tap filter instead of an n-tap filter may result from a determination that utilizing the m-tap filter will result in the utilization of less system resources (e.g., memory bandwidth resources) than utilizing the n-tap filter.

Note that in various non-limiting exemplary scenarios, the video information data points may correspond to video pixels. The video decoder 320 may, in such scenarios, decode at least a portion of the encoded video information to generate video information between the video pixels.

The exemplary video processing system 300 may also comprise a video display device 330, which is communicatively coupled to the video decoder 320 through various interface circuitry (e.g., display driver circuitry, etc.). The video display device 330 may generally receive one or more signals representative of decoded video information from the video decoder 320 and present the decoded video information in visible form. The video display device 330 may, for example, comprise characteristics of any of a variety of video display device types (e.g., as discussed previously regarding the display device 140 of the exemplary system 100 illustrated in FIG. 1).

The receiver 310, video decoder 320 and the video display device 330 may, for example, be integrated into a single enclosure or may reside in separate enclosures. For example, the receiver 310, video decoder 320 and the video display device 330 may be integrated into a television set, pocket computer or telephone. Alternatively for example, the receiver 310 and video decoder 320 may be integrated into a satellite receiver, cable receiver, computer, video server, personal video recorder, DVD player, etc., which is a physically separate device from the video display device 330. Accordingly, the scope of various aspects of the present invention should not be limited by any characteristics of any particular degree of system integration or co-location.

As discussed previously with regard to the exemplary video processing system 100 illustrated in FIG. 1, the various modules or components of the exemplary video processing system 100 may be implemented utilizing hardware, software and/or a combination thereof. Additionally, various modules may share various hardware and/or software components. For example and without limitation, a first module and a second module may share various hardware components or software sub-routines. Accordingly, the scope of various aspects of the present invention should not be limited by characteristics of any particular module implementations or by arbitrary notions of module boundaries.

The exemplary video processing system 300 was presented to provide specific illustrations of generally broader aspects of the present invention. Accordingly, the scope of various aspects of the present invention should not be limited by specific characteristics of the exemplary video processing system 300.

FIG. 4 is a flow diagram illustrating an exemplary method 400 for processing video information, in accordance with various aspects of the present invention. The exemplary method 400 may, for example and without limitation, share various functional characteristics with the exemplary video processing system 300 illustrated in FIG. 3 and discussed previously. Also, the exemplary method 400 may, for example, share various functional characteristics with the exemplary video processing system 100 and method 200 illustrated in FIGS. 1-2 and discussed previously.

As discussed previously with regard to the method 200 illustrated in FIG. 2, the exemplary method 400 may be implemented in any of a variety of devices or systems comprising video processing capability.

The exemplary method 400 may, at step 420, comprise receiving encoded video information, where the encoded video information resulted from a video encoding strategy that is based on a decoder utilizing an n-tap filter to interpolate between video information data points. Such a video encoding strategy may, for example and without limitation, comprise characteristics of a video block encoding strategy. Step 420 may, for example and without limitation, share various characteristics with step 220 of the exemplary method illustrated in FIG. 2 and discussed previously, and share various functional characteristics with the receivers 122, 310 of the exemplary systems 100, 300 illustrated in FIGS. 1 and 3 and discussed previously.

The exemplary method 400 may, at step 430, comprise decoding at least a portion of the encoded video information (e.g., as received at step 420) utilizing an m-tap filter to interpolate between video information data points, where m does not equal n. For example, m may be less than n. Step 430 may, for example and without limitation, share various characteristics with the step 250 of the exemplary method 200 illustrated in FIG. 2 and discussed previously, and share various functional characteristics with the video decoders 330, 124 of the exemplary systems 100, 300 illustrated in FIGS. 1 and 3 and discussed previously.

In a first non-limiting exemplary scenario, the encoded video information received at step 420 may comprise at least one video information stream, which comprises a first portion and a second portion. The second portion may, for example, be temporally sequentially related to the first portion. Step 430 may, for example, comprise decoding the first portion of the video information stream utilizing an n-tap filter to interpolate between video information data points, and decoding the second portion of the video information stream utilizing an m-tap filter to interpolate between video information data points. In the first non-limiting exemplary scenario, decoding the second portion of the video information stream utilizing an m-tap filter instead of an n-tap filter may result from a determination that utilizing the m-tap filter will result in the utilization of less system resources (e.g., memory bandwidth resources) than utilizing the n-tap filter.

In a second non-limiting exemplary scenario, the encoded video information received at step 420 may comprise at least one video information stream, which comprises a first portion and a second portion. The encoded video information may have been encoded in accordance with an encoding standard that specifies the utilization of an n-tap filter to interpolate between video information data points (e.g., n=6). Step 430 may, for example, comprise decoding the first portion of the video information stream utilizing an n-tap filter (e.g., n=6), as specified by the encoding standard, to interpolate between video information data points, and decoding the second portion of the video information stream utilizing an m-tap filter (e.g., m=2), in violation of the encoding standard, to interpolate between video information data points. In the second non-limiting exemplary scenario, decoding the second portion of the video information stream utilizing an m-tap filter instead of an n-tap filter may result from a determination that utilizing the m-tap filter will result in the utilization of less system resources (e.g., memory bandwidth resources) than utilizing the n-tap filter.

Note that in various non-limiting exemplary scenarios, the video information data points may correspond to video pixels. The step 430 may, in such scenarios, comprise decoding at least a portion of the encoded video information to generate video information between the video pixels.

The exemplary method 400 may, at step 440, comprise performing continued processing. Step 440 may, for example and without limitation, share various characteristics with step 260 of the exemplary method 200 illustrated in FIG. 2 and discussed previously. For example and without limitation, such continued processing may comprise characteristics of communicating decoded information with a display device, presenting visible information on the display device, performing various user interface functions, performing various error detection and fault management operations, etc. Also for example, such continued processing may comprise communicating the decoded video information to any of a variety of devices (e.g., video display devices) at any of a variety of locations. Accordingly, the scope of various aspects of the present invention should not be limited by characteristics of particular types of continued processing.

The exemplary method 400 was presented to provide specific illustrations of generally broader aspects of the present invention. Accordingly, the scope of various aspects of the present invention should not be limited by specific characteristics of the exemplary method 400.

The exemplary methods 200, 400 illustrated in FIGS. 2 and 4 and discussed previously, and the exemplary systems 100, 300 illustrated in FIGS. 1 and 3 and discussed previously may, for example, be implemented utilizing a wide range of hardware, software, or a combination thereof. For example, various aspects of the exemplary methods 200, 400 and systems 100, 300 may be implemented by a general-purpose processor or an application-specific processor executing software and/or firmware instructions. Also, for example, various aspects may be implemented by discrete hardware. Additionally, for example, various aspects may be implemented by a single integrated circuit or a set of integrated circuits. Further, for example, various aspects may be implemented by a single physical system or a distributed network of physical systems. Accordingly, the scope of various aspects of the present invention should not be limited by a particular system configuration or implementation of any of the exemplary methods or systems previously discussed.

In summary, various aspects of the present invention provide a system and method for processing video information. While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. In a video processing system, a method for processing video information, the method comprising:
receiving encoded video information;
determining an indication of utilization for at least one system resource of the video processing system;
identifying, based at least in part on the determined indication of utilization, which of a plurality of decoding strategies to utilize to decode the encoded video information; and
decoding the encoded video information according to the identified decoding strategy.

2. The method of claim 1, wherein determining an indication of utilization for at least one system resource of the video processing system comprises determining an indication of utilization for memory bandwidth.

3. The method of claim 2, wherein the plurality of decoding strategies comprises a first decoding strategy that utilizes a relatively high amount of memory bandwidth, and a second decoding strategy that utilizes a relatively low amount of memory bandwidth.

4. The method of claim 2, wherein the plurality of decoding strategies comprises:
a first decoding strategy that comprises utilizing an n-tap filter to interpolate video information; and
a second decoding strategy that comprises utilizing an m-tap filter to interpolate video information, where m is less than n.

5. The method of claim 4, wherein n equals six, and m equals two.

6. The method of claim 2, wherein determining an indication of utilization for memory bandwidth comprises:
determining current memory bandwidth utilization; and
determining the indication of utilization for memory bandwidth based, at least in part, on the current memory bandwidth utilization.

7. The method of claim 2, wherein determining an indication of utilization for memory bandwidth comprises:
predicting memory bandwidth utilization; and
determining the indication of utilization for memory bandwidth based, at least in part, on the predicted memory bandwidth utilization.

8. The method of claim 7, wherein predicting memory bandwidth utilization comprises:
predicting data access volume; and
predicting memory bandwidth utilization based, at least in part, on the predicted data access volume.

9. The method of claim 7, wherein predicting memory bandwidth utilization comprises:
determining data alignment in memory; and
predicting memory bandwidth utilization based, at least in part, on the determined data alignment.

10. The method of claim 2, wherein determining an indication of utilization for memory bandwidth comprises communicating with a memory controller to determine at least one of current memory bandwidth utilization and predicted memory bandwidth utilization.

11. The method of claim 1, wherein determining an indication of utilization for at least one system resource of the video processing system comprises determining an indication of utilization for system energy.

12. In a video processing system, a method for processing video information, the method comprising:
receiving encoded video information, wherein the encoded video information resulted from a video encoding strategy that is based on a decoder utilizing an n-tap filter to interpolate between video information data points; and
decoding at least a portion of the encoded video information utilizing an m-tap filter to interpolate between video information data points, where m is less than n.

13. The method of claim 12, wherein the encoded video information comprises a video information stream comprising a first portion and a second portion, and the method comprises decoding the first portion of the video information stream utilizing an n-tap filter to interpolate between video information data points, and decoding the second portion of the video information stream utilizing an m-tap filter to interpolate between video information data points.

14. The method of claim 12, wherein the video information data points correspond to video pixels, and decoding at least a portion of the encoded video information comprises utilizing an m-tap filter to generate video information between video pixels.

15. The method of claim 12, further comprising communicating the decoded video information to at least one device comprising video display capability.

16. A system for processing video information, the system comprising:
a receiver that receives encoded video information;
at least one module that determines an indication of utilization for at least one system resource of the video processing system;
at least one module that identifies, based at least in part on the determined indication of utilization, which of a plurality of decoding strategies to utilize to decode the encoded video information; and
a decoder that decodes the encoded video information according to the identified decoding strategy.

17. The system of claim 16, wherein at least one module determines an indication of utilization for at least one system resource of the video processing system by, at least in part, determining an indication of utilization for memory bandwidth.

18. The system of claim 17, wherein the plurality of decoding strategies comprises a first decoding strategy that utilizes a relatively high amount of memory bandwidth, and a second decoding strategy that utilizes a relatively low amount of memory bandwidth.

19. The system of claim 17, wherein the plurality of decoding strategies comprises:
a first decoding strategy that comprises utilizing an n-tap filter to interpolate video information; and
a second decoding strategy that comprises utilizing an m-tap filter to interpolate video information, where m is less than n.

20. The system of claim 19, wherein n equals six, and m equals two.

21. The system of claim 17, wherein the at least one module that determines an indication of utilization for memory bandwidth:
determines current memory bandwidth utilization; and
determines the indication of utilization for memory bandwidth based, at least in part, on the current memory bandwidth utilization.

22. The system of claim 17, wherein the at least one module that determines an indication of utilization for memory bandwidth:
predicts memory bandwidth utilization; and
determines the indication of utilization for memory bandwidth based, at least in part, on the predicted memory bandwidth utilization.

23. The system of claim 22, wherein the at least one module that predicts memory bandwidth utilization:
predicts data access volume; and
predicts memory bandwidth utilization based, at least in part, on the predicted data access volume.

24. The system of claim 22, wherein the at least one module that predicts memory bandwidth utilization:
determines data alignment in memory; and
predicts memory bandwidth utilization based, at least in part, on the determined data alignment.

25. The system of claim 17, wherein the at least one module determines an indication of utilization for memory bandwidth by communicating with a memory controller to determine at least one of current memory bandwidth utilization and predicted memory bandwidth utilization.

26. The system of claim 16, wherein at least one module determines an indication of utilization for at least one system resource of the video processing system by, at least in part, determining an indication of utilization for system energy.

27. A system for processing video information, the system comprising:
a receiver that receives encoded video information, wherein the encoded video information resulted from a video encoding strategy that is based on a decoder utilizing an n-tap filter to interpolate between video information data points; and
a decoder that decodes at least a portion of the encoded video information utilizing an m-tap filter to interpolate between video information data points, where m is less than n.

28. The system of claim 27, wherein:
the encoded video information comprises a video information stream comprising a first portion and a second portion; and
the decoder decodes the first portion of the video information stream utilizing an n-tap filter to interpolate between video information data points, and decodes the second portion of the video information stream utilizing an m-tap filter to interpolate between video information data points.

29. The system of claim 27, wherein:
the video information data points correspond to video pixels; and
the decoder decodes at least a portion of the encoded video information by utilizing an m-tap filter to generate video information between video pixels.

30. The system of claim 27, further comprising:
a device comprising video display capability; and
at least one module that communicates decoded video information to the device comprising video display capability.
